(19) United States
(12) Patent Application Publication
(10) Pub. No.: US 2023/0108162 A1
(43) Pub. Date: Apr. 6, 2023

(54) DATA COLLECTION SYSTEM, DATA COLLECTION DEVICE, DATA ACQUISITION DEVICE, AND DATA COLLECTION METHOD

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Akihito Ito, Inazawa-shi Aichi-ken (JP); Ryo Nakabayashi, Susono-shi Shizuoka-ken (JP); Tatsuya Imamura, Okazaki-shi Aichi-ken (JP); Tomohiro Kaneko, Mishima-shi Shizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/959,827

(22) Filed: Oct. 4, 2022

(30) Foreign Application Priority Data
Oct. 6, 2021 (JP) 2021-165030

(51) Int. Cl. G06N 5/02

(52) U.S. Cl. CPC G06N 5/022

(57) ABSTRACT

A data collection system has a data acquisition device located in a predetermined target area and a data collection device communicable with the data acquisition device, and collects data necessary for use or training of a machine learning model from the data acquisition device to the data collection device. The data collection system includes a processor configured to: determine whether a collection promotion condition is satisfied; and control data transmission. The processor controls data transmission from the data acquisition device to the data collection device so that an amount of data transmission per unit time is larger when it is determined that the collection promotion condition is satisfied, compared to when it is determined that the collection promotion condition is not satisfied.

### CROSS-REFERENCE TO RELATED APPLICATIONS

This application claims priority to Japanese Patent Application No. 2021-165030 filed Oct. 6, 2021, which is incorporated herein by reference in its entirety including the specification, drawings and abstract.

### TECHNICAL FIELD

The present disclosure relates to a data collection system, a data collection device, a data acquisition device, and a data collection method.

### BACKGROUND

In smart cities, it has been proposed to collect data from multiple entities within the community. In particular, in JP2013-069084A1, since there is uncertainty in data obtained from information systems of different business entities, it has been proposed to collect data obtained by correcting the obtained data in order to solve the uncertainty.

Incidentally, in a smart city or the like, various data are acquired by various data acquisition devices located in the smart city, for example, a surveillance camera, a mobile terminal of a person in the smart city, or the like. In addition, the servers capable of communicating with these data acquisition devices perform various processing (using or training a machine learning model) on the machine learning model based on the acquired data.

In order to perform various processing on such a machine learning model, the server needs to receive data from the data acquisition device. However, when all the data acquired by the data acquisition device is transmitted to the server and stored in the storage device of the server, a large amount of data is stored in the storage device, thereby requiring a storage device having a very large storage capacity.

In view of the above problems, it is an object of the present disclosure to efficiently collect data from a data acquisition device.

### SUMMARY

(1) A data collection system having a data acquisition device located in a predetermined target area and a data collection device communicable with the data acquisition device, and collecting data necessary for use or training of a machine learning model from the data acquisition device to the data collection device, the data collection system comprising a processor configured to:

determine whether a collection promotion condition for promoting data collection from the data acquisition device to the data collection device is satisfied; and

control data transmission from the data acquisition device to the data collection device, wherein

the processor is configured to control data transmission from the data acquisition device to the data collection device so that an amount of data transmission per unit time from the data acquisition device to the data collection device is larger in a case where it is determined that the collection promotion condition is satisfied, compared to a case where it is determined that the collection promotion condition is not satisfied.

(2) The data collection system of above (1), wherein

the data collection system collects data required for training the machine learning model, and

the collection promotion condition is a condition such that data collected from the data acquisition device when the collection promotion condition is satisfied contributes to an improvement in an accuracy of the machine learning model when used for training the machine learning model, compared to data collected from the data acquisition device when the collection promotion condition is not satisfied.

(3) The data collection system according to above (2), wherein

the machine learning model is a model for classifying into a plurality of classes, and

the collection promotion condition is a condition such that a probability of occurrence of a class having a relatively low probability of occurrence among the classes when the collection promotion condition is satisfied is higher than a probability of occurrence of a class having a relatively low probability of occurrence among the classes when the collection promotion condition is not satisfied.

(4) The data collection system according to above (2) or (3), wherein

the machine learning model is a model for classifying into a plurality of classes, and

the collection promotion condition is a condition that is satisfied when occurrence probabilities of all classes classified by the machine learning model are equal to or greater than a predetermined reference probability.

(5) The data collection system according to any one of above (1) to (4), wherein the processor is configured to control the transmission of data from the data acquisition device to the data collection device so that a frequency of transmission of data from the data acquisition device to the data collection device is higher when it is determined that the collection promotion condition is satisfied than when it is determined that the collection promotion condition is not satisfied.

(6) The data collection system of above (1), wherein the collection promotion condition is a condition that is satisfied when a reliability of each data received from the data acquisition device is equal to or less than a predetermined reference value.

(7) A data collection device capable of communicating with a data acquisition device located in a predetermined target area and collecting data necessary for use or training of a machine learning model from the data acquisition device, the data collection device comprising, a processor configured to:

determine whether a collection promotion condition for promoting data collection from the data acquisition device is satisfied; and

control transmission of data from the data acquisition device to the data collection device, wherein

the processor is configured to control transmission of data from the data acquisition device to the data collection device such that the amount of data transmission per unit time from the data acquisition device is greater when it is determined that the collection promotion condition is satisfied than when it is determined that the collection promotion condition is not satisfied.

(8) A data acquisition device capable of communicating with a data collection device and capable of acquiring data necessary for use or training of a machine learning model and transmitting the data to the data collection device, the data acquisition device comprising a processor configured to:

determine whether a collection promotion condition for promoting data collection to the data collection device is satisfied; and

control transmission of data to the data collection device, wherein

the processor is configured to control transmission of data to the data collection device such that an amount of data transmission to the data collection device per unit time is larger when it is determined that the collection promotion condition is satisfied than when it is determined that the collection promotion condition is not satisfied.

(9) A data collection method for collecting data necessary for use or training of a machine learning model from a data acquisition device located in a predetermined target area to a data collection device, the data collection method comprising:

determining whether or not a collection promotion condition for promoting data collection from the data acquisition device to the data collection device is satisfied; and

controlling transmission of data from the data acquisition device to the data collection device such that an amount of data transmission per unit time from the data acquisition device to the data collection device is larger when it is determined that the collection promotion condition is satisfied than it is determined that when the collection promotion condition is not satisfied.

### BRIEF DESCRIPTION OF THE DRAWINGS

FIG. 1 is a schematic configuration diagram of a machine learning system.

FIG. 2 is a diagram schematically showing a hardware configuration of a terminal device.

FIG. 3 is a functional block diagram of the processor of the terminal device.

FIG. 4 is a diagram schematically illustrating a hardware configuration of a server.

FIG. 5 is a functional block diagram of a processor of the server.

FIG. 6 is a diagram showing the probability of a user suffering from heat stroke under each condition.

FIG. 7 is a sequence diagram showing a flow of the training processing of the machine learning model.

FIG. 8 is a flowchart showing a flow of the target transmission frequency setting process performed in step S12 of FIG. 7.

FIG. 9 is a functional block diagram of the processor of the terminal device according to the second embodiment.

FIG. 10 is a functional block diagram of the processor of the server according to the second embodiment.

FIG. 11 is a sequence diagram showing a flow of training processing of the machine learning model in the second embodiment.

FIG. 12 is a schematic configuration diagram of a machine learning system according to a third embodiment.

FIG. 13 is a sequence diagram showing a flow of training processing of the machine learning model in the third embodiment.

FIG. 14 is a flowchart showing a flow of the target transmission frequency setting process performed in step S42 of FIG. 13.

### DESCRIPTION OF EMBODIMENTS

Hereinafter, embodiments will be described in detail with reference to the drawings. In the following description, similar components are denoted by the same reference numerals.

### First Embodiment

### Configuration of the Machine Learning System

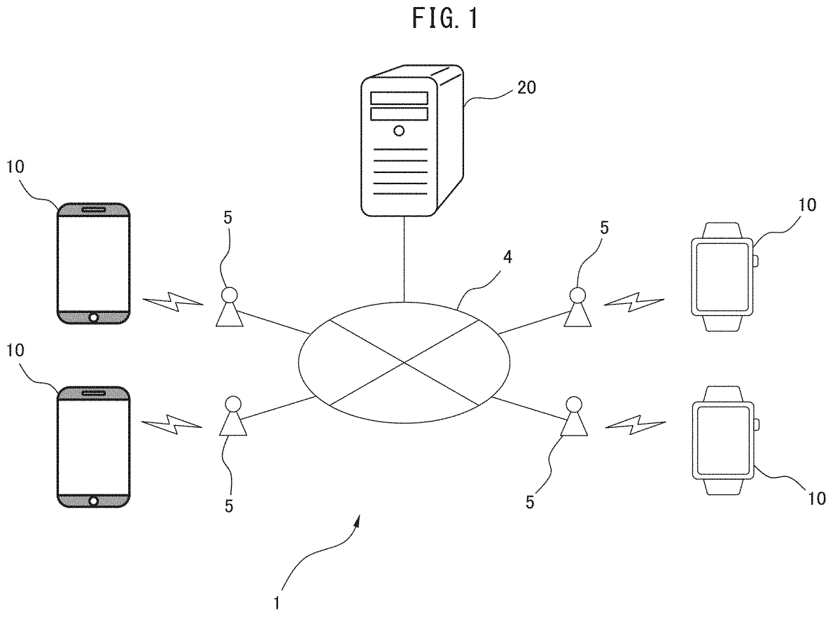

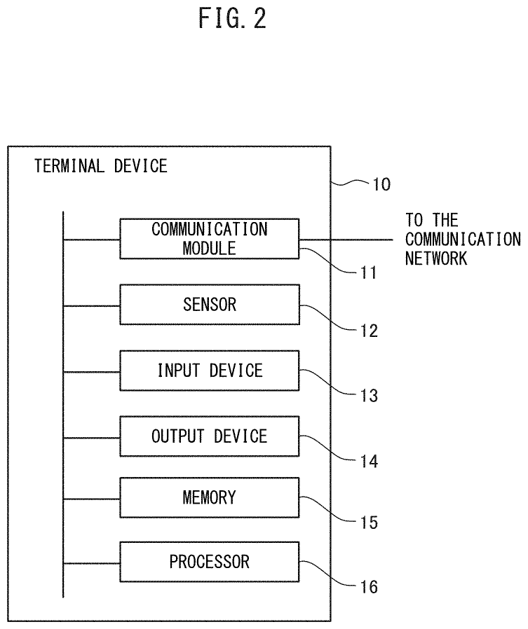

The configuration of the machine learning system 1 according to the first embodiment will be described with reference to FIGS. 1 and 2. FIG. 1 is a schematic configuration diagram of a machine learning system 1. The machine learning system 1 trains a machine learning model used in a server. The machine learning system 1 also functions as a data collection system for collecting data necessary for use and training of the machine learning model.

As shown in FIG. 1, the machine learning system 1 includes a plurality of mobile terminal devices 10 and a server 20 capable of communicating with the terminal devices 10. Each of the plurality of terminal devices 10 and the server 20 are configured to be able to communicate with each other via a communication network 4 configured by an optical communication line or the like and a radio base station 5 connected to the communication network 4 via a gateway (not shown). As the communication between the terminal device 10 and the radio base station 5, various broad-spectrum wireless communication protocols having a long communication distance can be used, for example, communication that conforms to any communication standard such as 4G, LTE, or 5G, WiMAX established by 3GPP, or IEEE is used.

In particular, in the present embodiment, the server 20 communicates with the terminal device 10 located within a predetermined target area. The target area is a range surrounded by predetermined boundaries. For example, it may be a smart city defined as “a sustainable city or region that solves various problems faced by cities and regions and continues to create new value, through the sophistication of management (planning, maintenance, management, operation, etc.) while utilizing new technologies such as ICT (information and communication technology).” The server 20 may be capable of communicating with the terminal device 10 located outside the target area.

The terminal device 10 is an example of a data acquisition device that acquires data necessary for use or training of a machine learning model, which will be described later. In particular, in the present embodiment, the terminal device 10 is a device that is individually held and acquires information of a person holding the terminal device 10. Therefore, in the present embodiment, the terminal device 10 functions as a mobile data acquisition device that acquires information of persons within a predetermined target area. Therefore, in the present embodiment, the terminal device 10 moves along with the movement of the individual holding the terminal device 10. Therefore, when an individual holding the terminal device 10 moves into the target area, the terminal device 10 held by the individual also moves into the target area. Conversely, when an individual holding the terminal device 10 moves out of the target area, the terminal device 10 held by the individual also moves out of the target area.

Specifically, in the present embodiment, the terminal device 10 includes, for example, a wearable terminal, such as a watch type terminal (smart watch), a wristband type terminal, a clip type terminal, and an eyeglass type terminal (smart glass), and a mobile terminal. The terminal device acquires information of each person, such as positional information, vital signs (body temperature, heart rate, blood pressure, and respiration rate), blood oxygen concentration, blood glucose level, and the like, of each person in the target area.

In the present embodiment, the terminal device 10 includes, in particular, a watch type terminal and a mobile terminal that communicates with the watch type terminal by short-range wireless communication. As the short-range radio communication protocol, for example, communication protocols conforming to any communication standard (for example, Bluetooth™ or ZigBee™) established by IEEE, ISO, IEC, or the like may be used.

FIG. 2 is a diagram schematically showing a hardware configuration of the terminal device 10. As shown in FIG. 2, the terminal device 10 includes a communication module 11, a sensor 12, an input device 13, an output device 14, a memory 15, and a processor 16. The communication module 11, the sensor 12, the input device 13, the output device 14 and the memory 15 are connected to the processor 16 via signal lines.

The communication module 11 is an example of a communication unit that communicates with other devices. The communication module 11 is, for example, a device for communicating with the server 20. In particular, the communication module 11 is a device that communicates with the radio base station 5 through the wide area wireless communication described above, so that the communication module 11 communicates with the server 20 through the radio base station 5 and the communication network 4.

The sensor 12 is an example of a detector that detects various parameters relating to the situation of terminal device 10 and the situation around terminal device 10. In particular, the sensor 12 has a plurality of discrete sensors that detect different parameters. The values of the various parameters detected by the sensor 12 are transmitted to the processor 16 or the memory 15 via signal lines.

Specifically, the sensor 12 includes a GNSS receiver that detects the present position of the terminal device 10. The sensor 12 also includes a sensor for detecting parameters relating to a user holding the terminal device 10. For example, in the case where the terminal device 10 is a watch type terminal (smart watch), the sensor 12 may include a sensor for detecting data (e.g., vital signs such as heart rate, body temperature, blood pressure, and respiration rate, blood oxygen concentration, electrocardiogram, blood glucose level, number of steps, calorie consumption, fatigue, sleep state, etc.) relating to the physical condition of the user wearing the terminal device 10. The sensor 12 may also include a sensor that detects environmental data around the terminal device 10. For example, the terminal device 10 may include a sensor that detects air temperature or humidity around the terminal device 10.

The input device 13 is a device for the user of the terminal device 10 to input. Specifically, the input device 13 includes a touch panel, a microphone, a button, a dial, or the like. Information input via the input device 13 is transmitted to the processor 16 or the memory 15 via a signal line.

The output device 14 is a device for the terminal device 10 to output. Specifically, the output device 14 includes a display, a speaker, or the like. The output device 14 performs output based on a command transmitted from the processor 16 via a signal line. For example, the display may display an image on the screen based on commands from the processor 16, and/or the speaker may output sounds based on instructions from the processor 16.

The memory 15 includes, for example, a volatile semiconductor memory (e.g., RAM), a nonvolatile semiconductor memory (e.g., ROM), or the like. The memory 15 stores a computer program for executing various processing by the processor 16, various data used when various processing is executed by the processor 16, and the like. The memory 15 stores, for example, a machine learning model, specifically, the configuration of the machine learning model and model parameters such as weights and biases, which will be described later.

The processor 16 includes one or more CPUs (Central Processing Unit) and peripheral circuits thereof. The processor 16 may further comprise an arithmetic circuit, such as a logical arithmetic unit or a numerical arithmetic unit. The processor 16 executes various kinds of processing based on a computer program stored in the memory 15. Specific processing executed by the processor 16 of the terminal device 10 will be described later.

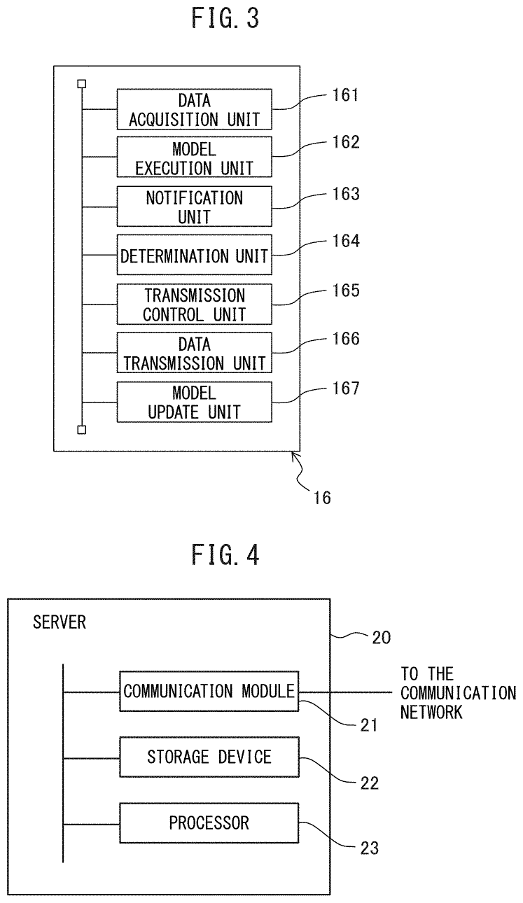

FIG. 3 is a functional block diagram of the processor 16 of the terminal device 10. As shown in FIG. 3, the processor 16 of the terminal device 10 includes a data acquisition unit 161, a model execution unit 162, a notification unit 163, a determination unit 164, a transmission control unit 165, a data transmission unit 166, and a model update unit 167. These functional blocks of the processor 16 of the terminal device 10 are functional modules implemented, for example, by a computer program running on the processor 16. Alternatively, the functional blocks included in the processor 16 may be dedicated arithmetic circuits provided in the processor 16. The details of each of these functional blocks will be described later.

The server 20 is connected to a plurality of terminal devices 10 via a communication network 4. In the present embodiment, the server 20 functions as a training device for training a machine learning model used in the terminal device 10. The server 20 also functions as a data collection device that collects data necessary for training the machine learning model from a plurality of terminal devices 10.

FIG. 4 is a diagram schematically showing a hardware configuration of the server 20. The server 20 includes a communication module 21, a storage device 22, and a processor 23, as illustrated in FIG. 4. The server 20 may include input devices such as a keyboard and a mouse, and output devices such as a display and a speaker.

The communication module 21 is an example of a communication device for communicating with devices outside the server 20. The communication module 21 comprises an interface circuit for connecting the server 20 to the communication network 4. The communication module 21 is configured to be able to communicate with each of the plurality of terminal devices 10 via the communication network 4 and the radio base station 5.

The storage device 22 is an example of a storage device for storing data. The storage device 22 includes, for example, a hard disk drive (HDD), a solid state drive (SSD), or an optical recording medium. The storage device 22 may include a volatile semiconductor memory (e.g., RAM), a nonvolatile semiconductor memory (e.g., ROM), or the like. The storage device 22 stores a computer program for executing various processing by the processor 23 and various data used when various processing is executed by the processor 23. In particular, the storage device 22 stores data received from the terminal device 10 and data used for training the machine learning model.

The processor 23 has one or a plurality of CPUs and peripheral circuits thereof. The processor 23 may further comprise a GPU or an arithmetic circuit such as a logical or numerical unit. The processor 23 executes various kinds of processing based on a computer program stored in the storage device 22. Specific processing executed by the processor 23 of the server 20 will be described later.

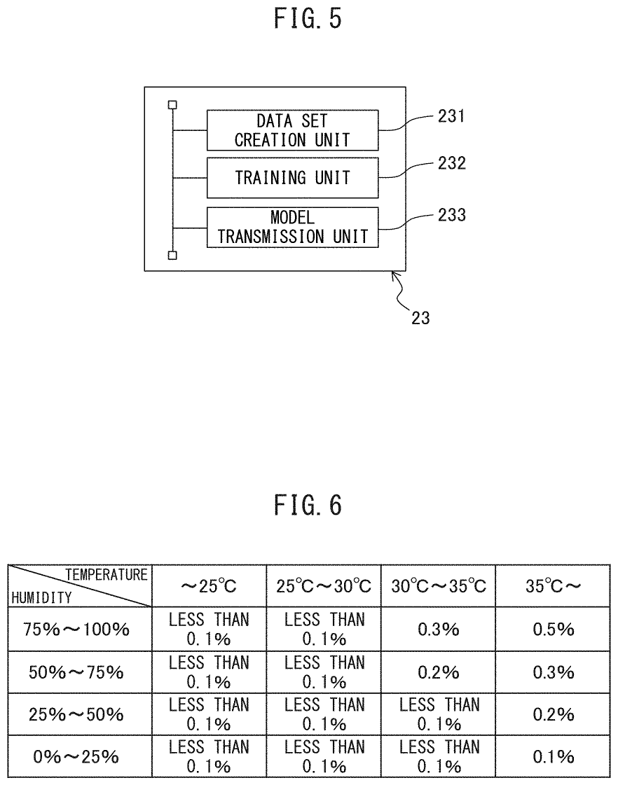

FIG. 5 is a functional block diagram of the processor 23 of the server 20. As shown in FIG. 5, the processor 23 includes a data set creation unit 231, a training unit 232, and a model transmission unit 233. These functional blocks of the processor 23 of the server 20 are, for example, functional modules implemented by computer programs running on the processor 23. Alternatively, the functional blocks included in the processor 23 may be dedicated arithmetic circuits provided in the processor 23.

### Machine Learning Model

In the present embodiment, when a predetermined process is performed in the terminal device 10, a machine learning model subjected to machine learning is used. In the present embodiment, the machine learning model is a model for performing classification to a plurality of classes based on data acquired from the sensor 12 of the terminal device 10. Hereinafter, a machine learning model which estimates whether or not a person holding the terminal device 10 suffers from heat stroke (i.e., classifying a class representing that the person suffers from heat stroke and a class representing that the person does not suffer from heat stroke), based on data acquired from the sensor 12 of the terminal device 10, will be described as an example.

Specifically, in the present embodiment, data relating to the state of the user's body such as vital signs, blood oxygen concentration, and electrocardiogram of the user holding the terminal device 10, and environmental data such as air temperature and humidity around the terminal device 10 are input as input parameters to the machine learning model. Data relating to the body of the user holding the terminal device 10 and environment data are acquired from the sensor 12 of the terminal device 10. Alternatively, the environmental data may be obtained from the server 20 via the communication module 11 rather than from the sensor 12. When input parameters are input to the machine learning model, the machine learning model outputs whether or not the user holding the terminal device 10 suffers from heat stroke.

Various machine learning algorithms can be used for the machine learning model. In the present embodiment, the machine learning model is a model trained by supervised learning, such as a neural network (NN), a support vector machine (SVM), or a decision tree (DT). In particular, in the present embodiment, the machine learning model may be a recurrent neural network (RNN) model in which data relating to the state of the user's body and environment data are input as input parameters in time series.

As the machine learning model, a model having various input parameters and output parameters can be used. The input parameters may include various parameters that can be detected by the sensor 12 of the terminal device 10. Specifically, the input parameters may include, for example, vital signs (heart rate, body temperature, blood pressure, and respiration rate), blood oxygen concentration, electrocardiogram, blood glucose level, number of steps, calorie consumption, fatigue, sleep state, time, image, moving image, and the like. The input parameters may include parameters transmitted from the server 20 via the communication network 4 (for example, the temperature, humidity, weather, wind speed, and the like around the terminal device 10). In addition, the output parameters may include various parameters relating to the body of the user. Specifically, the output parameters may include, for example, the probability that the person holding the terminal device 10 will experience hypothermia.

In the present embodiment, the training of the machine learning model as described above is performed not by the terminal device 10 but by the server 20. The machine learning model is trained using a training data set. The training data set includes data used as input parameters and values of output parameters corresponding to the data (such as ground truth values or ground truth labels). In particular, in the present embodiment, the training data set includes time series data acquired by the terminal device 10 for a certain subject and data on whether the subject suffers from heat stroke. For example, in the case where the output parameter is whether or not the person suffers from heat stroke as described above, the value of the class representing that the person suffers from heat stroke among the output parameters is set to 1 in the training data set created for the person suffering from heat stroke. On the other hand, in the training data set created for the person who does not suffer from heat stroke, the value of the class representing that the person does not suffer from heat stroke among the output parameters is set to 1. The training data set may be generated by performing preprocessing (e.g., processing for missing data, normalization, standardization, etc.) on the output value of the sensor 12.

In training the machine learning model, for example, any known technique (e.g., an error back propagation method) may be used to repeatedly update the model parameters in the machine learning model (i.e., parameters whose values are updated by training, such as weights w and biases b of NN). The model parameters are repeatedly updated so that, for example, the difference between the output value of the machine learning model and the ground truth value of the output parameter included in the training data set becomes small. As a result, the machine learning model is trained, and a trained machine learning model is generated.

### Use of Machine Learning Models

Next, processing using the machine learning model in the terminal device 10 will be described with reference to FIG. 3. In the present embodiment, the terminal device 10 estimates whether or not the user holding the terminal device 10 suffers from heat stroke, based on the values of the various parameters detected by the sensor 12 of the terminal device 10. In addition, the terminal device 10 notifies the user that there is a risk of heat stroke when it is determined that heat stroke is likely. The processor 16 of the terminal device 10 estimates whether or not the user suffers from heat stroke using the data acquisition unit 161, the model execution unit 162, and the notification unit 163.

The data acquisition unit 161 acquires data including data relating to input parameters of the machine learning model. Specifically, the data acquisition unit 161 acquires the values of the input parameters detected by the sensor 12 of the terminal device 10. In the present embodiment, the data acquisition unit 161 acquires the body temperature, the heart rate, the blood pressure, the respiration rate, and the like of the user from the sensor 12. The data acquisition unit 161 may acquire the values of the input parameters from an external device such as the server 20 via the communication module 11. In the present embodiment, the server 20, when receiving the current position detected by the sensor 12 of each terminal device 10, transmits the current temperature and the current humidity around the position to the terminal device 10. Therefore, the data acquisition unit 161 acquires the temperature and humidity around the terminal device 10 from the server 20. Data acquired by the data acquisition unit 161 is stored in the memory 15.

When the data acquisition unit 161 acquires the current values of the input parameters of the machine learning model, the model execution unit 162 inputs the acquired values of the input parameters to the machine learning model, and calculates the value of the output parameter. In the present embodiment, in the model execution unit 162, when the data relating to the body of the user and the environment data acquired by the data acquisition unit 161 are input to the machine learning model, whether the user suffers from heat stroke or not is output.

Here, the program for executing the machine learning model and the values of the model parameters used in the machine learning model are stored in the memory 15. Therefore, the model execution unit 162 calculates the value of the output parameter using the values of the program and the model parameters stored in the memory 15.

The notification unit 163 notifies the user based on the value of the output parameter calculated by the model execution unit 162. The notification unit 163 notifies the user via the output device 14. Specifically, in the present embodiment, when the model execution unit 162 determines that the user suffers from heat stroke, the notification unit 163 notifies the user via the output device 14. In this case, for example, the notification unit 163 may display a warning regarding heat stroke on the display, or may generate a warning sound regarding heat stroke from a speaker.

### Training of Machine Learning Models

Next, the training process of the machine learning model used in the model execution unit 162 of each terminal device 10 will be described with reference to FIGS. 3 and 5-8. In the present embodiment, the training of the machine learning model is performed in the server 20. Specifically, the terminal device 10 transmits the training data acquired in the terminal device 10 to the server 20. The server 20 trains the machine learning model by using the received training data, and transmits the trained machine learning model to the terminal device 10. Then, the terminal device 10 updates the machine learning model to the transmitted trained model.

The processor 16 of the terminal device 10 uses the data acquisition unit 161, the determination unit 164, the transmission control unit 165, the data transmission unit 166, and the model update unit 167 to train the machine learning model (see FIG. 3). In addition, the processor 23 of the server 20 uses the data set creation unit 231, the training unit 232, and the model transmission unit 233 to train the machine learning model (see FIG. 5).

Incidentally, in training the machine learning model for estimating whether or not the user suffers from heat stroke on the basis of the data acquired from the terminal device 10, the data acquired by the terminal device 10 is transmitted to the server 20. However, when all of the data acquired by all of the terminal devices 10 is transmitted to the server 20 and stored in the storage device 22 of the server 20, a large amount of data is stored in the storage device 22. Therefore, a storage device 22 with very large storage capacity is required.

On the other hand, the probability of the user holding each terminal device 10 suffering from heat stroke is low. Therefore, if the data acquired by all the terminal devices 10 is used to train the machine learning model, the data in the case where the user does not suffer from heat stroke is excessive, and the machine learning model with high estimation accuracy cannot necessarily be created. For this reason, not all of the data in the case where the user does not suffer from heat stroke needs to be used.

FIG. 6 is a diagram showing the probability of a user suffering from heat stroke under each condition. In particular, FIG. 6 shows the probability of a user suffering from heat stroke for each condition defined by temperature and humidity. As shown in FIG. 6, the higher the temperature and the higher the humidity, the higher the probability of the user suffering from heat stroke. On the other hand, when the temperature is low or the humidity is low, the probability of the user suffering from heat stroke is low. Therefore, in the present embodiment, in a condition in which the probability of the user suffering from heat stroke is relatively high (a condition in which the probability in the figure is 0.1% or more), the transmission frequency of the data acquired by the terminal device 10 to the server 20 is set higher. On the other hand, in a condition in which the probability of the user suffering from heat stroke is relatively low (the probability is less than 0.1% in the figure), the transmission frequency of the data acquired by the terminal device 10 to the server 20 is set lower. In the following description, a condition in which the frequency of transmission of data to the server 20 is set high and collection of data to the server 20 is promoted (in the present embodiment, a condition in which the probability of the user suffering from heat stroke is relatively high) is also referred to as a collection promotion condition.

Here, as described above, the machine learning model of the present embodiment is a model for classifying a class representing that a patient suffers from heat stroke and a class representing that the patient does not suffer from heat stroke. Since the user holding each terminal device 10 has a low probability of suffering from heat stroke, it can be said that the class representing suffering from heat stroke has a relatively low probability of occurrence. Therefore, it is considered that the collection promotion condition is a condition in which the occurrence probability of a class having a relatively low occurrence probability when the collection promotion condition is satisfied is higher than the occurrence probability of a class having a relatively low occurrence probability when the collection promotion condition is not satisfied.

Further, as described above, the probability that the user does not suffer from heat stroke is high under any condition. Thus, for example, under a condition in which the probability of the user suffering from heat stroke is relatively high, for example, under a condition in which the probability is 0.1% or more in FIG. 6, the occurrence probability is 0.1% or more in both the class representing that the user suffers from heat stroke and the class representing that the user does not suffer from heat stroke. Therefore, the collection promotion condition can be considered to be a condition satisfied when the occurrence probabilities of all classes classified by the machine learning model are equal to or more than a predetermined reference probability (0.1% in the example shown in FIG. 6).

Further, as described above, since the probability of the user suffering from heat stroke is low, data when the user suffers from heat stroke contributes to improvement in the estimation accuracy of the machine learning model as compared with data when the user does not suffer from heat stroke. Therefore, the collection promotion condition can be considered to be a condition that the data collected from the terminal device 10 when the collection promotion condition is satisfied contributes to the improvement of the accuracy of the machine learning model when used for the training of the machine learning model, compared to the data collected from the terminal device 10 when the collection promotion condition is not satisfied.

The determination unit 164 of the terminal device 10 determines whether or not the collection promotion condition for promoting data collection from the terminal device 10 to the server 20 is satisfied. In the present embodiment, the determination unit 164 determines whether or not the collection promotion condition is satisfied based on the temperature and humidity around the terminal device 10 acquired by the data acquisition unit 161. In particular, in the present embodiment, when the temperature and humidity around the terminal device 10 satisfy the condition in which the probability of the user suffering from heat stroke is 0.1% or more in FIG. 6, the determination unit 164 determines that the collection promotion condition is satisfied. On the other hand, in FIG. 6, when the temperature and humidity around the terminal device 10 satisfy the condition in which the probability of the user suffering from heat stroke is less than 0.1%, the determination unit 164 determines that the collection promotion condition is not satisfied.

The transmission control unit 165 of the terminal device 10 controls the transmission of data from the terminal device 10 to the server 20. The transmission control unit 165 controls, for example, the frequency of data transmission from the terminal device 10. In other words, the transmission control unit 165 controls the ratio of the data to be transmitted to the server 20 among the data acquired by the terminal device 10. Therefore, when the data transmission frequency is controlled to be high, for example, all the data acquired by the terminal device 10 (all the data used for the machine learning model) is transmitted to the server 20. On the other hand, when the data transmission frequency is controlled to be low, part of the data acquired by the terminal device 10 (some of the data used in the machine learning model) is transmitted to the server 20.

The data transmission unit 166 of the terminal device 10 transmits the data acquired from the sensor 12 of the terminal device 10 by the data acquisition unit 161 to the server 20 via the communication network 4. The data transmitted to the server 20 includes the values of the input parameters of the machine learning model, since the data is used to train the machine learning model. When the value of the output parameter is detected by the sensor 12 of the terminal device 10 (for example, when the machine learning model is a model that estimates the future value of the output parameter from the value of the input parameter), the data transmitted to the server 20 may include the value of the output parameter.

In particular, in the present embodiment, the data transmission unit 166 transmits data to the server 20 in accordance with a command from the transmission control unit 165. Therefore, the data transmission unit 166 transmits data to the server 20 at the transmission frequency set by the transmission control unit 165.

As described above, the model update unit 167 of the terminal device 10 updates the machine learning model used by the model execution unit 162 stored in the memory 15 to the machine learning model transmitted by the model transmission unit 233.

The data set creation unit 231 of the server 20 creates a training data set used for training the machine learning model. The training data set includes measured values of input parameters of the machine learning model and ground truth values or ground truth labels of output parameters. For example, in the present embodiment, the training data set includes time series data acquired by the terminal device 10 of a certain user, and suffering information (ground truth label) of heat stroke of the user.

The time series data acquired by each user's terminal device 10 is transmitted from each terminal device 10 to the server 20 by the data transmission unit 166. When creating the training data set, the data set creation unit 231 uses the data transmitted from each terminal device 10 in this manner.

In the present embodiment, when the user suffers from heat stroke, the information is input to the terminal device 10 via the input device 13 by the user himself/herself. The information on the occurrence of heat stroke input to the terminal device 10 is transmitted to the server 20 via the communication network 4. The data set creation unit 231 uses the heat stroke information in creating the training data set.

Alternatively, when the user suffers from heat stroke, the information is input by the medical institution that diagnosed the user, via a terminal device (not shown) connected to the communication network 4. The information on the occurrence of heat stroke input by the terminal device of the medical institution is transmitted to the server 20 via the communication network 4. In creating the training data set, the data set creation unit 231 may use the heat stroke suffering information transmitted in this manner.

The training unit 232 of the server 20 uses the training data set to train the machine learning model by a technique such as the error back propagation method as described above. Specifically, the training unit 232 updates the values of the model parameters of the machine learning model using the training data set.

The model transmission unit 233 of the server 20 transmits the trained machine learning model subjected to the machine learning by the training unit 232 to each terminal device 10 via the communication network 4. Specifically, the values of the model parameters updated by the training by the training unit 232 are transmitted to each terminal device 10.

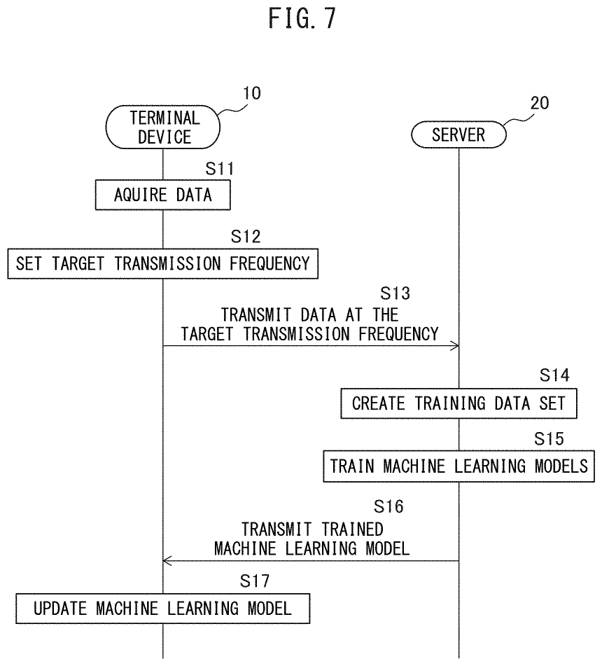

FIG. 7 is a sequence diagram showing a flow of training processing of a machine learning model used in the model execution unit 162. The training processing illustrated in FIG. 7 is executed in the processor 16 of the terminal device 10 and the processor 23 of the server 20.

In the training processing in the present embodiment, as shown in FIG. 7, the data acquisition unit 161 of the processor 16 of each terminal device 10 periodically acquires various data from the sensor 12 or the server 20 (Step S11). In the present embodiment, the data acquisition unit 161 acquires data relating to the input parameters of the machine learning model and data necessary for determining whether or not the collection promotion condition is satisfied. In particular, in the present embodiment, the data acquisition unit 161 acquires data relating to the temperature and humidity around the terminal device 10 as data necessary for determining whether or not the collection promotion condition is satisfied.

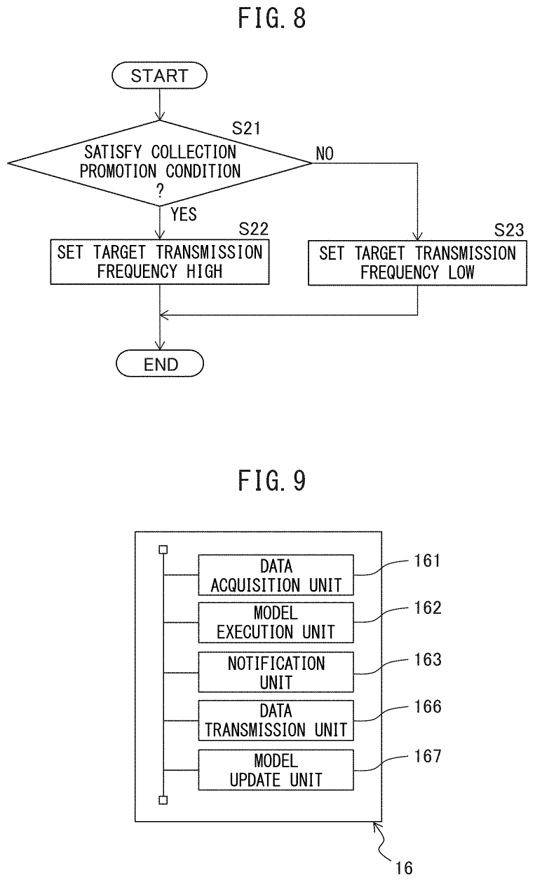

When the data acquisition unit 161 acquires the data, the determination unit 164 and the transmission control unit 165 set the target transmission frequency (Step S12). FIG. 8 is a flowchart showing the flow of the target transmission frequency setting process performed in step S12.

As shown in FIG. 8, when setting the target transmission frequency, first, the determination unit 164 determines whether or not the collection promotion condition is satisfied (Step S21). The collection promotion condition is set in advance artificially or automatically. In the present embodiment, the determination unit 164 determines whether or not the collection promotion condition is satisfied as described above, based on the data relating to the air temperature and the humidity acquired by the data acquisition unit 161 in step S11.

When it is determined in step S21 that the collection promotion condition is satisfied, the transmission control unit 165 sets the target transmission frequency of data from the terminal device 10 to the server 20 to be high (Step S22). Specifically, for example, the transmission control unit 165 sets the target transmission frequency so that all data acquired by the terminal device 10 is transmitted to the server 20. On the other hand, if it is determined in step S21 that the collection promotion condition is not satisfied, the transmission control unit 165 sets the target transmission frequency of data from the terminal device 10 to the server 20 to be low (Step S23). Specifically, for example, the transmission control unit 165 sets the target transmission frequency such that some of the data acquired by the terminal device 10 is transmitted to the server 20.

When the target transmission frequency is set in this manner, the data transmission unit 166 transmits the data to the server 20 at the set target transmission frequency (Step S13 of FIG. 7). In particular, the data transmission unit 166 transmits data used for the machine learning model among the data acquired by the data acquisition unit 161. The data transmitted to the server 20 is stored in the storage device 22 of the server 20.

When the data transmitted by the data transmission unit 166 is stored in the storage device 22, the data set creation unit 231 of the server 20 creates a training data set (Step S14). The data set creation unit 231 creates a training data set using data stored in the storage device 22 as input parameters. In addition, the data set creation unit 231 creates a training data set by using the heat stroke suffering information input to the terminal device 10 by the user himself/herself or the heat stroke suffering information input to the terminal device of the medical institution, as the ground truth value of the output parameter.

When the number of training data sets necessary for training is created by the data set creation unit 231 in step S14, the training unit 232 trains the machine learning model, using the created data set (Step S15). The training of the machine learning model is performed by a known method such as the error back propagation method as described above.

When the training of the machine learning model by the training unit 232 is completed, the model transmission unit 233 transmits the trained machine learning model to the terminal device 10 (Step S16). Upon receiving the trained machine learning model, the model update unit 167 of the terminal device 10 updates the machine learning model used by the model execution unit 162 to the machine learning model transmitted from the server 20 (Step S17).

### Effects and Modifications

According to the present embodiment, when a specific collection promotion condition is satisfied, data is transmitted from the terminal device 10 to the server 20 at a high frequency. On the other hand, when the collection promotion condition is not satisfied, data is transmitted from the terminal device 10 to the server 20 at a low frequency. Therefore, data necessary for training with high accuracy is transmitted to the server 20 with high frequency. On the other hand, data which is not so necessary for training with high accuracy is transmitted to the server 20 at a low frequency. As a result, it is possible to create a machine learning model with high estimation accuracy, while suppressing excessive data transmission from the terminal device 10 to the server 20. Therefore, according to the present embodiment, data can be efficiently collected from the terminal device 10.

In the above embodiment, the transmission control unit 165 controls the transmission of the data from the terminal device 10 to the server 20 so that the frequency of the transmission of the data from the terminal device 10 to the server 20 is higher when it is determined that the collection promotion condition is satisfied than when it is determined that the collection promotion condition is not satisfied. However, when it is determined that the collection promotion condition is satisfied, the transmission control unit 165 may control the transmission of data to the server 20 in any manner as long as the amount of decimation of data to be transmitted from the terminal device 10 to the server 20 can be reduced and the amount of data to be transmitted from the terminal device 10 to the server 20 per unit time can be increased, compared with the case where it is determined that the collection promotion condition is not satisfied. For example, the transmission control unit 165 may control the data transmission rate instead of the data transmission frequency.

Therefore, in the present embodiment, the terminal device 10 includes a determination unit 164 that determines whether or not the collection promotion condition is satisfied, and a transmission control unit 165 that controls transmission of data to the server 20. Then, when it is determined that the collection promotion condition is satisfied, as compared with the case where it is determined that the collection promotion condition is not satisfied, the transmission control unit 165 controls transmission of data to the server 20 so that the amount of data transmitted per unit time to the server 20 is large.

In the above embodiment, a machine learning model for estimating whether or not a patient suffers from heat stroke is used. However, any model may be used as the machine learning model as long as the model estimates the value of an arbitrary output parameter based on data acquired by a data acquisition device such as the terminal device 10. Therefore, the machine learning model may be, for example, a model for estimating the presence or absence and the position of an abnormal person (suspicious person, a person who may have suffered from a sudden illness, or the like) in the image data, based on the image data acquired by the surveillance camera.

In addition, in the above embodiment, the machine learning model is used in the terminal device 10. However, the machine learning model may also be used in the server 20. In this case, the data acquisition unit 161, the model execution unit 162, and the like are provided in the server 20. The data acquisition unit of the server 20 acquires data detected by the sensor 12 of the terminal device 10 from the terminal device 10 via the communication network 4. Then, the model execution unit 162 of the server 20 inputs the data received from the terminal device 10 as an input parameter to the machine learning model to calculate the value of the output parameter. In this case, the transmission control unit 165 may control the transmission from the terminal device 10 not only for the data used for the training of the machine learning model, but also for the data used for the execution of the machine learning model.

### Second Embodiment

Next, the machine learning system 1 according to the second embodiment will be described with reference to FIGS. 9 to 11. The following description focuses on points different from the machine learning system according to the first embodiment. In the first embodiment, the target transmission frequency is set in the terminal device 10, whereas in the second embodiment, the target transmission frequency is set in the server 20.

FIG. 9 is a functional block diagram, similar to FIG. 3, of the processor 16 of the terminal device 10 according to the second embodiment. As shown in FIG. 9, the processor 16 includes a data acquisition unit 161, a model execution unit 162, a notification unit 163, a data transmission unit 166, and a model update unit 167. Therefore, the processor 16 does not include the determination unit 164 and the transmission control unit 165.

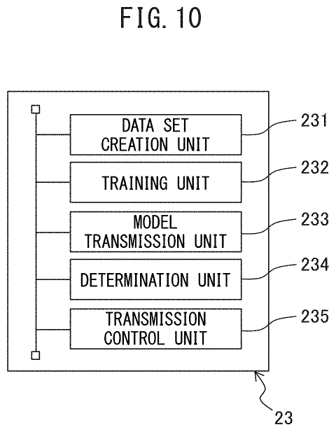

FIG. 10 is a functional block diagram, similar to FIG. 5, of the processor 23 of the server 20 according to the second embodiment. As shown in FIG. 5, the processor 23 includes a data set creation unit 231, a training unit 232, a model transmission unit 233, a determination unit 234, and a transmission control unit 235. The determination unit 234 determines whether or not the collection promotion condition is satisfied, similarly to the determination unit 164 of the first embodiment. Similarly to the transmission control unit 165 of the first embodiment, the transmission control unit 235 controls the transmission of data from the terminal device 10 to the server 20.

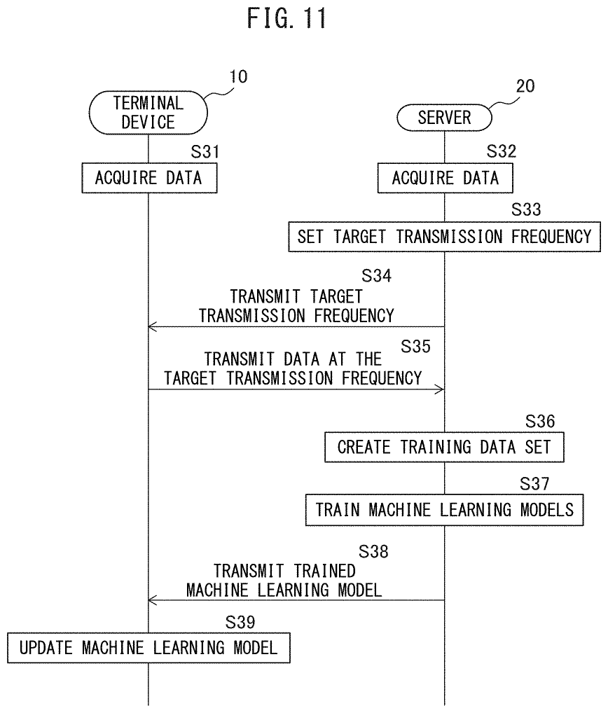

FIG. 11 is a sequence diagram, similar to FIG. 7, showing the flow of the training process of the machine learning model. The training process illustrated in FIG. 11 is performed in the processor 16 of the terminal device 10 and the processor 23 of the server 20. Steps S31 and S35 to S39 in FIG. 11 are the same as steps S11 and S13 to S17 in FIG. 7, and therefore description thereof is omitted.

In the training process according to the present embodiment, as shown in FIG. 11, the processor 23 of the server 20 acquires data relating to the air temperature and humidity in the region where the terminal device 10 that can communicate with the server 20 is located, for example, from another server (Step S32). When the processor 23 of the server 20 acquires the data, the determination unit 234 and the transmission control unit 235 of the server 20 set the target transmission frequency (Step S33). The setting of the target transmission frequency is performed according to the flowchart shown in FIG. 8.

When the target transmission frequency is set in step S33, the processor 23 of the server 20 transmits data relating to the set target transmission frequency to the respective terminal devices 10 (Step S34). The data transmission unit 166 of the terminal device 10 transmits the data to the server 20 at the transmitted target transmission frequency (Step S35).

As described above, in the present embodiment, the server 20 includes the determination unit 234 for determining whether or not the collection promotion condition is satisfied, and the transmission control unit 235 for controlling the transmission of data from the terminal device 10 to the server 20. When it is determined that the collection promotion condition is satisfied, the transmission control unit 235 controls the transmission of data from the terminal device 10 to the server 20 so that the amount of data transmitted from the terminal device 10 per unit time is larger than when it is determined that the collection promotion condition is not satisfied. Also in the present embodiment, similarly to the first embodiment, it is possible to create a machine learning model with high estimation accuracy, while suppressing excessive data transmission from the terminal device 10 to the server 20.

### Third Embodiment

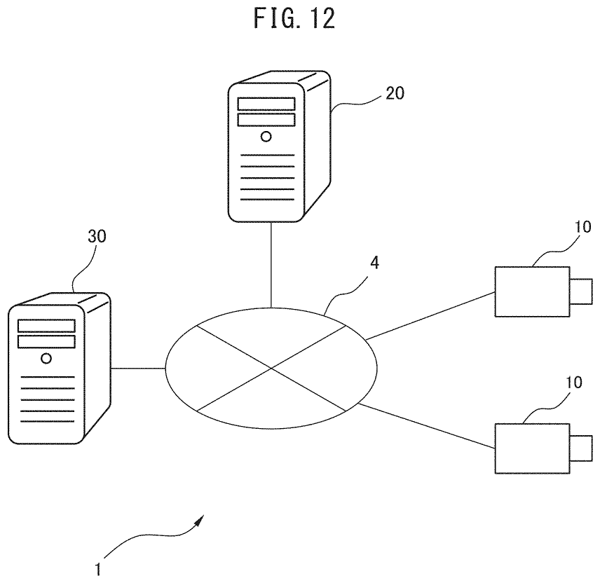

Next, a machine learning system 1 according to a third embodiment will be described with reference to FIGS. 12 to 14. The following description focuses on points different from the machine learning system according to the first embodiment and the second embodiment.

In the above embodiment, when the collection promotion condition is satisfied, the amount of data transmitted per unit time from the terminal device 10 to the server 20 is increased. In the above embodiment, the collection promotion condition is a condition in which the occurrence probability of a class having a low occurrence probability is high. In contrast, in the present embodiment, the collection promotion condition is a condition such that the reliability of the data transmitted from the terminal device 10 to the server 20 is low.

FIG. 12 is a schematic configuration diagram of the machine learning system 1 according to the third embodiment. As illustrated in FIG. 12, the machine learning system 1 includes a plurality of terminal devices 10, an external server 30, and a server 20 that can communicate with the terminal devices 10 and the external server 30. In the present embodiment, the terminal device 10 and the external server 30 and the server 20 are connected via the communication network 4.

Each of the terminal device 10 and the external server 30 is an example of a data acquisition device that acquires data necessary for use or training of a machine learning model. In the present embodiment, the terminal device 10 is a camera that shoots a predetermined region within the target area. In particular, the terminal device 10 is a fixed monitoring camera for photographing a predetermined area. The external server 30 acquires the environment information of each region in the target area. Specifically, the external server 30 acquires environment information such as air temperature, humidity, weather, event information, and the like of each region in the target area from a sensor or the like connected to the external server 30.

In the present embodiment, the machine learning model is a model for performing regression based on data acquired by the external server 30. In particular, in the present embodiment, when inputting environment information of each region in the target area, the machine learning model estimates the number of people expected to gather in the region or the comfort degree of people gathering in the region.

The ground truth value of the output parameter used for training the machine learning model is calculated based on the data acquired by the terminal device 10. Specifically, for example, object detection is performed for an image captured by the surveillance camera, thereby a person in the image is identified. The number of persons included in the image is calculated by counting the number of identified persons. When the surveillance camera is shooting a specific region within a specific target area, the number of persons within the specific region is calculated. Further, the comfort degree of each person is estimated based on the image of the facial expression of each person identified by the object detection. The number of people and the comfort degree in each region calculated or estimated in this manner are used as ground truth data for training the machine learning model.

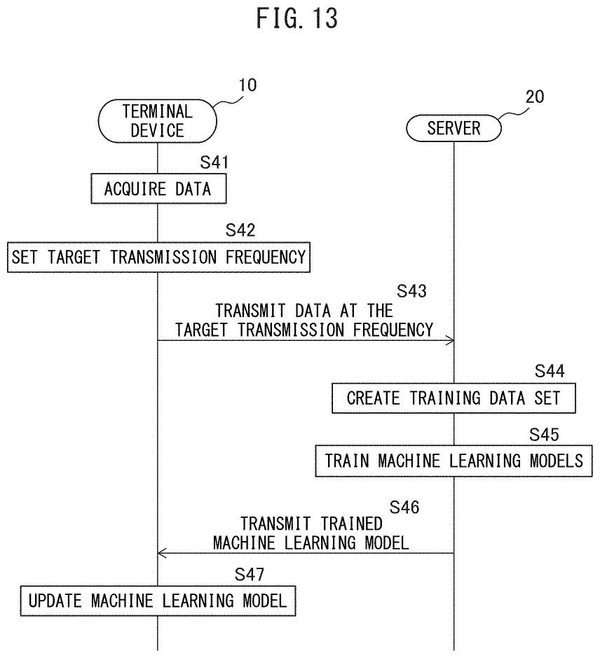

FIG. 13 is a sequence diagram showing the flow of the training process of the machine learning model. The training process illustrated in FIG. 13 is performed in the processor 16 of the terminal device 10 and in the processor 23 of the server 20. Steps S45 to S47 in FIG. 13 are the same as steps S15 to S17 in FIG. 7, and therefore description thereof is omitted.

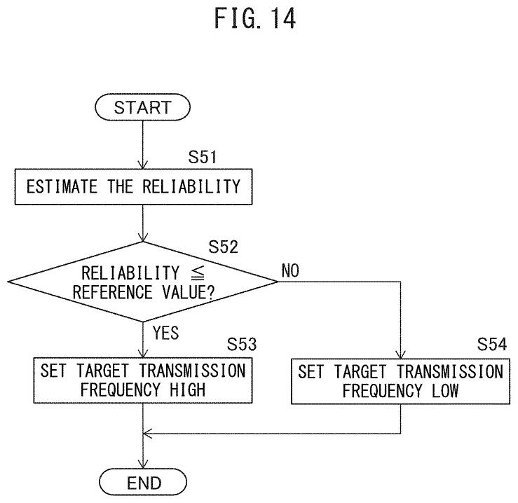

In the training process in the present embodiment, as shown in FIG. 13, first, the data acquisition unit 161 of the processor 16 of each terminal device 10 periodically acquires image data from a sensor (camera) (step S41). When the data acquisition unit 161 acquires the data, the determination unit 164 and the transmission control unit 165 set the target transmission frequency (Step S42). FIG. 14 is a flowchart showing the flow of the target transmission frequency setting process performed in step S42.

As shown in FIG. 14, when setting the target transmission frequency, first, the determination unit 164 estimates the reliability of the data acquired by the data acquisition unit 161 (Step S51). The degree of reliability of the data is calculated based on, for example, the number of people represented overlapping in the image, the degree of sharpness of the image, and the like. The larger the number of people represented overlapping in the image and the lower the sharpness of the image, the lower the reliability of the data is calculated. The number of people in the image which are represented by overlapping and the degree of sharpness of the image are calculated by, for example, a model which outputs values of these parameters when an image is input.

When the reliability of the data acquired by the data acquisition unit 161 is estimated, the determination unit 164 determines whether or not the collection promotion condition is satisfied. In particular, in the present embodiment, the determination unit 164 determines whether or not the collection promotion condition is satisfied based on whether or not the estimated reliability is equal to or less than a predetermined reference value (Step S52).

When it is determined in step S52 that the collection promotion condition is satisfied, that is, when it is determined that the estimated reliability is equal to or less than the reference value, the transmission control unit 165 sets the target transmission frequency of data from the terminal device 10 to the server 20 to be high (Step S53). On the other hand, when it is determined in step S52 that the collection promotion condition is not satisfied, that is, when it is determined that the estimated reliability is higher than the reference value, the target transmission frequency of data from the terminal device 10 to the server 20 is set to be low (Step S54).

When the target transmission frequency is set in this manner, the data transmission unit 166 transmits the data to the server 20 at the set target transmission frequency (Step S43 of FIG. 13). The data transmitted to the server 20 is stored in the storage device 22 of the server 20.

When the data transmitted by the data transmission unit 166 is stored in the storage device 22, the data set creation unit 231 of the server 20 creates a training data set (Step S44). The data set creation unit 231 performs object detection or the like on the image data stored in the storage device 22 to calculate or estimate the number of persons in the image represented by the image data and the comfort level of the persons in the image. The training data set is generated by using the number of people and the comfort degree in each region calculated or estimated in this manner as the ground truth value of the output parameter. The data set creation unit 231 creates a training data set using the temperature, humidity, weather, event information, and the like acquired from the external server 30 as input parameters.

When the number of training data sets necessary for training is created by the data set creation unit 231 in step S44, the training unit 232 uses the created data set to train the machine learning model (Step S45).

In the present embodiment, when the reliability of the data is low, the collection promotion condition is satisfied, and thus the data is transmitted from the terminal device 10 to the server 20 at a high frequency. Thus, when the reliability of the data is low, the amount of data to be transmitted to the server 20 is large. As the amount of data transmitted to the server 20 increases, the training accuracy of the machine learning model increases accordingly. On the other hand, when the reliability of the data is high, the collection promotion condition is not satisfied, and thus the data is transmitted from the terminal device 10 to the server 20 at a low frequency. As a result, also in the present embodiment, it is possible to create a machine learning model with high estimation accuracy while suppressing excessive data transmission from the terminal device 10 to the server 20.

While preferred embodiments of the present disclosure have been described above, the present disclosure is not limited to these embodiments, and various modifications and changes may be made within the scope of the appended claims.

1. A data collection system having a data acquisition device located in a predetermined target area and a data collection device communicable with the data acquisition device, and collecting data necessary for training of a machine learning model from the data acquisition device to the data collection device, the data collection system comprising a processor,
the processor being configured to:
determine whether a collection promotion condition for promoting data collection from the data acquisition device to the data collection device is satisfied; and
control data transmission from the data acquisition device to the data collection device, wherein
the processor is configured to control data transmission from the data acquisition device to the data collection device so that an amount of data transmission per unit time from the data acquisition device to the data collection device is larger in a case where it is determined that the collection promotion condition is satisfied, compared to a case where it is determined that the collection promotion condition is not satisfied,
the machine learning model is a model for classifying into a plurality of classes, and
the collection promotion condition is a condition relating to a probability of occurrence of the classes such that data collected from the data acquisition device when the collection promotion condition is satisfied contributes to an improvement in an accuracy of the machine learning model when used for training the machine learning model, compared to data collected from the data acquisition device when the collection promotion condition is not satisfied.

2. The data collection system according to claim 1, wherein
the collection promotion condition is a condition such that a probability of occurrence of a class having a relatively low probability of occurrence among the classes when the collection promotion condition is satisfied is higher than a probability of occurrence of a class having a relatively low probability of occurrence among the classes when the collection promotion condition is not satisfied.

3. The data collection system according to claim 1, wherein
the collection promotion condition is a condition that is satisfied when occurrence probabilities of all classes classified by the machine learning model are equal to or greater than a predetermined reference probability.

4. The data collection system according to claim 1, wherein the processor is configured to control the transmission of data from the data acquisition device to the data collection device so that a frequency of transmission of data from the data acquisition device to the data collection device is higher when it is determined that the collection promotion condition is satisfied than when it is determined that the collection promotion condition is not satisfied.

5. A data collection device capable of communicating with a data acquisition device located in a predetermined target area and collecting data necessary for training of a machine learning model from the data acquisition device, the data collection device comprising a processor,
the processor is configured to:
determine whether a collection promotion condition for promoting data collection from the data acquisition device is satisfied; and
control transmission of data from the data acquisition device to the data collection device, wherein
the processor is configured to control transmission of data from the data acquisition device to the data collection device such that an amount of data transmission per unit time from the data acquisition device is greater when it is determined that the collection promotion condition is satisfied than when it is determined that the collection promotion condition is not satisfied,
the machine learning model is a model for classifying into a plurality of classes, and
the collection promotion condition is a condition relating to a probability of occurrence of the classes such that data collected from the data acquisition device when the collection promotion condition is satisfied contributes to an improvement in an accuracy of the machine learning model when used for training the machine learning model, compared to data collected from the data acquisition device when the collection promotion condition is not satisfied.

6. A data acquisition device capable of communicating with a data collection device and capable of acquiring data necessary for training of a machine learning model and transmitting the data to the data collection device, the data acquisition device comprising a processor,
the processor is configured to:
determine whether a collection promotion condition for promoting data collection to the data collection device is satisfied; and
control transmission of data to the data collection device, wherein
the processor is configured to control transmission of data to the data collection device such that an amount of data transmission to the data collection device per unit time is larger when it is determined that the collection promotion condition is satisfied than when it is determined that the collection promotion condition is not satisfied,
the machine learning model is a model for classifying into a plurality of classes, and
the collection promotion condition is a condition relating to a probability of occurrence of the classes such that data collected from the data acquisition device when the collection promotion condition is satisfied contributes to an improvement in an accuracy of the machine learning model when used for training the machine learning model, compared to data collected from the data acquisition device when the collection promotion condition is not satisfied.

7. A data collection method for collecting data necessary for use or training of a machine learning model from a data acquisition device located in a predetermined target area to a data collection device, the data collection method comprising:
determining whether or not a collection promotion condition for promoting data collection from the data acquisition device to the data collection device is satisfied; and
controlling transmission of data from the data acquisition device to the data collection device such that an amount of data transmission per unit time from the data acquisition device to the data collection device is larger when it is determined that the collection promotion condition is satisfied than it is determined that when the collection promotion condition is not satisfied, wherein
the machine learning model is a model for classifying into a plurality of classes, and
the collection promotion condition is a condition relating to a probability of occurrence of the classes such that data collected from the data acquisition device when the collection promotion condition is satisfied contributes to an improvement in an accuracy of the machine learning model when used for training the machine learning model, compared to data collected from the data acquisition device when the collection promotion condition is not satisfied.

8. A data collection system having a data acquisition device located in a predetermined target area and a data collection device communicable with the data acquisition device, and collecting data necessary for training of a machine learning model from the data acquisition device to the data collection device, the data collection system comprising a processor,
the processor being configured to:
determine whether a collection promotion condition for promoting data collection from the data acquisition device to the data collection device is satisfied; and
control data transmission from the data acquisition device to the data collection device, wherein
the processor is configured to control data transmission from the data acquisition device to the data collection device so that an amount of data transmission per unit time from the data acquisition device to the data collection device is larger in a case where it is determined that the collection promotion condition is satisfied, compared to a case where it is determined that the collection promotion condition is not satisfied,
the machine learning model is a model for classifying into a plurality of classes, and
the collection promotion condition is a condition such that a probability of occurrence of a class having a relatively low probability of occurrence among the classes when the collection promotion condition is satisfied is higher than a probability of occurrence of a class having a relatively low probability of occurrence among the classes when the collection promotion condition is not satisfied.

9. A data collection system having a data acquisition device located in a predetermined target area and a data collection device communicable with the data acquisition device, and collecting data necessary for training of a machine learning model from the data acquisition device to the data collection device, the data collection system comprising a processor,
the processor being configured to:
determine whether a collection promotion condition for promoting data collection from the data acquisition device to the data collection device is satisfied; and
control data transmission from the data acquisition device to the data collection device, wherein
the processor is configured to control data transmission from the data acquisition device to the data collection device so that an amount of data transmission per unit time from the data acquisition device to the data collection device is larger in a case where it is determined that the collection promotion condition is satisfied, compared to a case where it is determined that the collection promotion condition is not satisfied,
the machine learning model is a model for classifying into a plurality of classes, and
the collection promotion condition is a condition that is satisfied when occurrence probability of all classes classified by the machine learning model are equal to or greater than a predetermined reference probability.
